(19) United States
(12) Patent Application Publication
(10) Pub. No.: US 2008/0126624 A1
(43) Pub. Date: May 29, 2008

(54) Memory buffer and method for buffering data

(76) Inventors: Edoardo Prete, Dresden (DE); Hans-Peter Trost, Munich (DE); Anthony Sanders, Haar (DE); Gernot Steinlesberger, Munich (DE); Maurizio Skerlj, Munich (DE); Dirk Scheideler, Munich (DE); Georg Braun, Holzkirchen (DE); Steve Wood, Munich (DE); Richard Johannes Luyken, Munich (DE)

Correspondence Address: SLATER & MATSIL LLP, 17950 PRESTON ROAD, SUITE 1000, DALLAS, TX, 75252, US

(21) Appl. No.: 11/604,665

(22) Filed: Nov. 27, 2006

(51) Int. Cl. G06F 3/00

(52) U.S. Cl. 710/53

(57) ABSTRACT

A memory buffer comprises a first asynchronous latch chain interface connectable to at least one of a memory controller and a memory buffer, a second data interface connected to a memory device, and a circuit comprising a buffer and a processor, the circuit being coupled to the first and the second interfaces, so that data can be passed between the first interface and the buffer and between the second interface and the buffer and so that the processor is capable of processing at least one of the data from the first interface to the second interface and the data from the second interface according to a data processing functionality, wherein the data processing functionality of the processor is changeable by a programming signal received via an interface of a memory buffer.

### TECHNICAL FIELD

The present invention relates to a memory buffer and a method for buffering data, such as a memory buffer, which can be implemented in modern high-capacity memory systems, for instance, in the field of server applications and graphic systems.

### BACKGROUND

Modern computer systems and many applications of modern computer systems require more and more memory, as the complexity and the number of details to be taken into account by the software applications are rapidly growing.

Examples come, for instance, from the fields of technical, economical, social, and scientific simulations concerning the behavior of complex systems. Further examples come from the fields of data processing, data mining, and further data related activities. These applications not only require an enormous amount of memory on disc drives, magnetic or optical tapes and other memory systems capable of storing and archiving great amounts of data, both, temporarily and permanently, but also require a growing amount of the main memory of a computer, especially, for instance, that of a server or a workstation. Further examples come from the field of computer graphics in the context of simulating complex and detailed surfaces, objects and structures.

To cope with the problem of the growing demand for main memory, not only have the memory devices (e.g., DRAM memory devices; DRAM=Dynamic Random Access Memory) been increased in terms of their memory capacity, but also a greater number of individual devices have been coupled to a single memory controller by introducing, as a possible solution, memory buffers interconnected between the memory controller and a set of memory devices.

However, due to the increased memory capacity of such memory systems, a new challenge of providing the memory controller with data stored in the memory devices in a fast and reliable way has emerged.

### SUMMARY OF THE INVENTION

According to an embodiment of the present invention, a memory buffer comprises a first asynchronous latch chain interface connectable to at least one of a memory controller and a memory buffer, a second data interface connectable to a memory device and a circuit comprising a buffer and a processor, the circuit being coupled to the first and second interfaces so that data can be passed between the first interface and the buffer and between the second interface and the buffer, and so that the processor is capable of processing at least one of the data from the first interface to the second interface and the data from the second interface according to a data processing functionality, wherein the data processing functionality of a processor is changeable by a programming signal received via an interface of the memory buffer.

According to a further embodiment of the invention, a memory buffer comprises a first asynchronous latch chain connectable to at least one of a memory controller and a memory buffer, a second interface connectable to a memory device and a circuit comprising a buffer and a processor, the circuit being coupled to the first and the second interface for buffering data between the first interface and the buffer of buffering data between the second interface and the buffer, and so that the processor is able to process data between the first interface and the second interface, according to a changeable data processing functionality, based on a programming signal received via the first interface of the memory buffer.

### BRIEF DESCRIPTION OF THE DRAWINGS

Embodiments of the present invention are described hereinafter, making reference to the appended drawings.

FIG. 1 shows a block diagram of an embodiment of a memory buffer;

FIG. 2 shows a block diagram of an arrangement of fully buffered DIMMs with embodiments of a memory buffer with a memory controller;

FIG. 3 shows a block diagram of an arrangement of a host, a memory buffer, and a memory device;

FIG. 4 shows a diagram of an embodiment of a memory system with a host memory controller, a memory device, and an embodiment of a memory buffer;

FIGS. 5a and 5b show examples of a data readout in the case of a DRAM memory device; and

FIG. 6 shows schematically the content of a (cache) memory of an embodiment of an inventive memory buffer.

### DETAILED DESCRIPTION OF ILLUSTRATIVE EMBODIMENTS

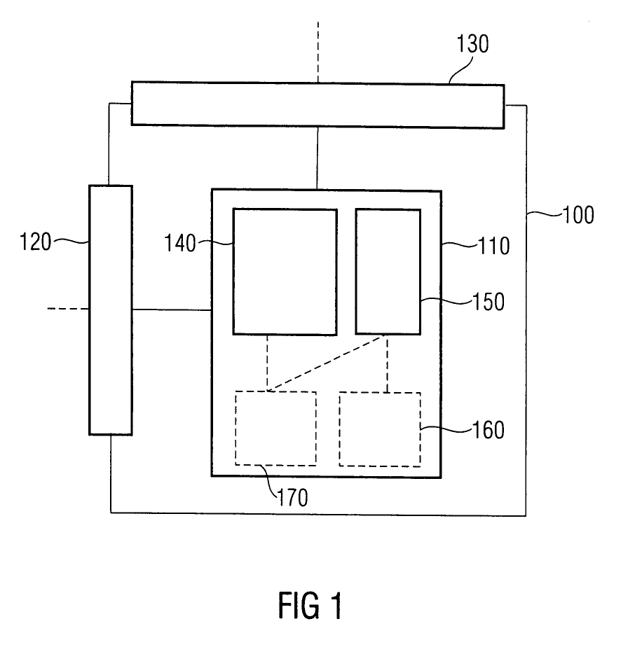

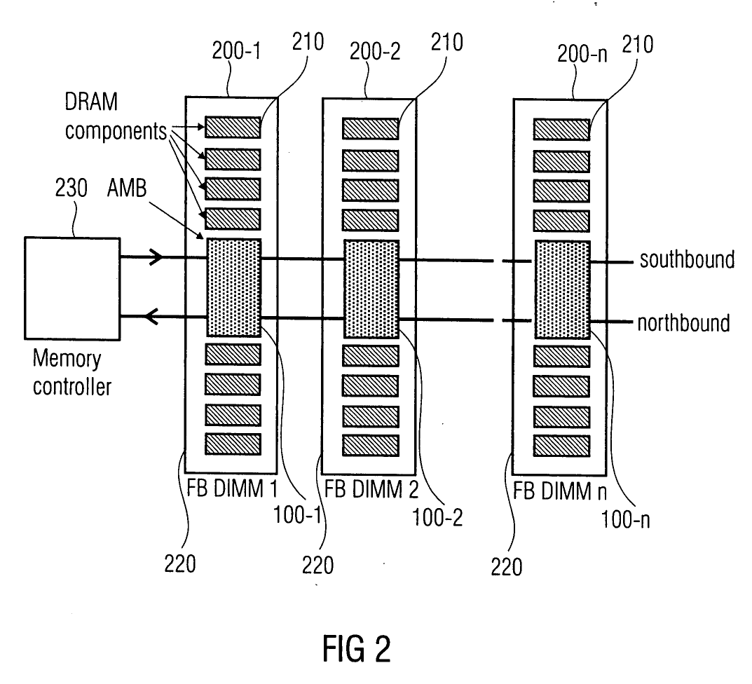

FIGS. 1 to 6 show block diagrams and examples of data stored in memories in context with embodiments of memory buffers. Before a second embodiment of the present invention is described with respect to FIGS. 2 to 6, a first embodiment of a memory buffer is explained with respect to the schematic representation in the form of a block diagram of FIG. 1.

FIG. 1 shows a memory buffer 100 comprising a circuit 110, which is coupled to a first asynchronous latch chain interface 120 and to a second data interface 130. The first asynchronous latch chain interface or first interface 120 is connectable to a memory controller or a further memory buffer, whereas the second data interface 130 is connectable to a memory device such as a DRAM memory device (DRAM=Dynamic Random Access Memory).

Depending on the concrete implementation of an embodiment of a memory buffer 100, such a DRAM memory device can, for instance, be a DDRx memory device (DDR=Double Data Rate), wherein x is an integer indicating a DDR standard. A typical example of a DDR memory device or a DDR1 memory device (x=1) are DDR SDRAM memory systems (DDR SDRAM=Double Data Rate Synchronous Dynamic Random Access Memory) which are typically used as main memory in a personal computer (PC). However, other DDR memory devices can also be connected to the second data interface depending on the concrete implementation of the embodiment of the memory buffer 100. Examples comprise, for instance, DDR2, DDR3 and DDR4 memory devices. Hence, in some embodiments the second interface 130 is a parallel interface. However, other memory devices can also be connected to the second data interface 130 of an embodiment of the data buffer 100, depending on its concrete implementation. In principle, also SRAM memory devices (SRAM=Static Random Access Memory) or non-volatile memory devices (e.g., flash memory) can be connected to embodiments of a memory buffer 100.

Embodiments of the memory buffer 100 can be incorporated or coupled to a memory system comprising a memory controller, in a so-called daisy chain configuration wherein each component of the daisy chain is connected via asynchronous latch chain interfaces with the next component. As will be explained in more detail later, in a daisy chain configuration, a daisy chain network, or a daisy chain, each component can only communicate with its neighboring components in the daisy chain. As an example, if a component wants to send information, data, commands or other signals to a component, which is not a neighboring component in the daisy chain, the respective signals will first be sent to its direct neighbor, which then forwards the data to the next component on the daisy chain. This is done, until the signals reach their final destination in the form of the intended component. The communication in the reverse direction can in principle be done via a direct communication over a bus system connecting each component with each other, especially the target component with a component sending the original signals. Alternatively, each component can be connected to each other in terms of the reverse direction via an individual communication connection. However, also the communication in the reverse direction can be done in terms of a daisy chain or a daisy chain configuration by sending signals from one component or stage of the daisy chain to its neighbor until the target component or the intended component receives the respective signals or information.

In a memory system, especially a memory controller forms a first or a central (latch) stage in such a daisy chain. The memory controller is then connected via an asynchronous latch chain to a neighboring or first memory buffer, which is then furthermore connected to a second memory buffer and so on, until the end of the daisy chain is reached. As a consequence, the embodiment of the memory buffer 100 can furthermore comprise an optional asynchronous latch chain interface, which is connectable to a further memory buffer or a further component on the daisy chain. Accordingly, the circuit 110 is in this case also connected to the optional further asynchronous latch chain interface, which is not shown in FIG. 1 for simplicity reasons only.

Moreover, the circuit 110 comprises a buffer 140, so that signals, data and instructions can be passed between the first asynchronous latch chain interface 120 and the buffer 140, and furthermore between the buffer 140 and the second data interface 130. The buffer 140, hence, enables buffering and transferring data between the first asynchronous latch chain interface 120 and the second data interface. In other words, the buffer 140 enables especially a data exchange between a component connected to the first asynchronous latch chain interface, such as a memory controller or a further memory buffer, and a memory device connectable or coupled to the second data interface 130. The buffer 140 mainly serves as a router, routing data and requests between the first asynchronous latch chain interface 120 and the second data interface 130.

If an embodiment of a memory buffer 100 further comprises a further asynchronous latch chain interface as an option, the buffer 140 is also coupled to the further asynchronous latch chain interface to enable furthermore an exchange, transfer or routing of data, commands, status requests, status signals or other signals between the buffer 140 and the further asynchronous latch chain interface 120, as well as with the first asynchronous latch chain interface 120 and the second data interface 130 via the buffer 140.

The embodiment of a memory buffer 100 shown in FIG. 1 further comprises a processor 150 comprised in the circuit 110, coupled to the first asynchronous latch chain interface 120 and the second data interface 130. The processor 150 is able to process at least the data from the first interface to the second interface and the data from the second interface according to a data processing functionality, which is changeable and defined by a programming signal, which is received from one of the interfaces 120, 130 of the embodiment of the memory buffer 100. The processor 150 can, depending on the concrete implementation of an embodiment of a memory buffer 100, be a standard processor, a RISC (RISC=Reduced Instruction Set Computing) or an even more specialized processor.

However, it is important to note that the processor 150 is a processor, which is capable of executing instructions, a code, software or a program and thereby achieving a goal, which can, for instance, comprise manipulating or processing data. In other words, the processor 150 is capable of executing a program or a software comprising instructions to perform a task defined by the software or the program, which can, for instance, comprise manipulating data exchanged between the circuit 110 and the first asynchronous latch chain interface 120 and the second data interface 130. To be even more precise, the processor 150 can manipulate data on their way from the first asynchronous latch chain interface 120 to the second data interface 130. Furthermore, the processor 150 can manipulate or process data from the second data interface 130.

However, it should be noted that the processor 150 is capable of executing a program indicative of the data processing functionality to be executed on the data on their way between the first asynchronous latch chain interface and the second data interface. In order to execute the data processing functionality and in order to execute the program, the processor 150 executes instructions and other code, comprised in the program indicative of the data processing functionality. In contrast to a simple ASIC (ASIC=Application Specific Integrated Circuit) the processor 150 usually comprises a program counter, which indicates a memory address at which the current or the next instruction to be executed by the processor 150 is stored. As a consequence, an embodiment of the memory buffer 100 furthermore comprises as an additional optional component, a memory or a code memory 160, which is coupled to the processor 150 and in which the program or code indicative of the data processing functionality of the processor 150 is stored. In other words, the memory 160 is coupled to the processor 150 to store the code or instructions comprised in the programming signal received from one of the interfaces 120, 130 and to provide the processor 150 with the instructions of a code to enable the processor 150 to carry out the data processing functionality.

By executing a program or software to carry out a changeable data processing functionality the processor 150 is capable of executing, manipulating or processing data received at the first asynchronous latch chain interface 120 on its way to the second data interface 130 or data received from the second data interface 130. Hence, a main difference between the processor 150 and a simple ASIC is the programmability or the changeable data processing functionality.

An embodiment of the memory buffer 100 can furthermore comprise, as an additional optional component, a memory, a temporary memory, or a cache memory 170, which can be coupled to at least one of the buffer 140 and the processor 150. Depending on the concrete implementation, the memory 170 or a cache memory 170 can thus be used for caching data exchanged between the first asynchronous latch chain interface 120 and the second data interface 130 in either or both directions. As a consequence, the cache memory 170, if connected to the buffer, is in principle capable of providing a faster access to data stored in one or more memory devices coupled to the second data interface 130.

If the memory 170 or cache memory 170 is alternatively or additionally coupled to the processor 150, the processor 150 can access the cache memory 170 in processing the data. As will be explained later, the cache memory 170 can in this case, be used as a temporary memory or a “local main memory” of the processor 150, in which temporary, intermediate or final results of the data processing can be stored to and optionally accessed by the buffer 140 during buffering data between the at least two interfaces 120, 130.

In a concrete implementation, an embodiment of a memory buffer 100 can comprise two input buffers for each of the two interfaces, the first asynchronous latch chain interface 120 and the second data interface 130, each. In such a concrete implementation, the processor 150 of the circuit 110 can be connected or coupled in between the two input buffers of the buffer 140. In other words, the processor 150 can in such an implementation be arrayed between the first input buffer of the first asynchronous latch chain interface 120, and the second input buffer of the second data interface 130. However, in such an implementation, the two input buffers of the two interfaces 120, 130 are comprised in the buffer 140, shown in FIG. 1. Furthermore, a buffering of data is performed by the processor by not processing or manipulating the data on their way. In some embodiments of the memory buffer 100, the processor 150 comprises a special set of instructions, which enables a programmable, changeable data processing functionality or capability to be incorporated into an embodiment of the memory buffer 100. According to the special implementations, the set of instructions of the processor 150 can, for instance, comprise instructions for error detection, error correction, fast Fourier transformation (FFT), direct cosine transformation (DCT) or other complex, arithmetical manipulation of data.

In this context, in the framework of the present application, a first component, which is coupled to a second component, can be directly connected or connected via a further circuitry a further component to the second component. In other words, in the framework of the present application, two components being coupled to each other comprise the alternatives of the two components being directly connected to each other, or via a further circuitry or a further component. As an example, a memory device coupled to the second data interface 130 of an embodiment of the memory buffer 100 can either be directly connected to the interface 130 or via an additional circuitry or via a printed circuit board or another connector.

An advantage of an embodiment of a memory buffer 100, as for instance shown in FIG. 1, is that a data processing functionality is introduced to the memory buffer by incorporating the processor into the memory buffer, which allows a data processing very close to the memory devices being connectable to the second data interface. Furthermore, compared to a simple ASIC, by incorporating the processor 150, a great flexibility with respect to the data processing functionality comprised in the memory buffer 100 in the form of the processor 150 is reached. This furthermore enables a significant reduction of data traffic between the memory devices and a memory controller being connectable to the first asynchronous latch chain interface.

In other words, by introducing a changeable data processing functionality by implementing the processor 150 into an embodiment of a memory buffer 100, a flexible, programmable and hence, changeable data processing capability is introduced to the memory buffer 100, which reduces the required data traffic between the memory buffer and the memory controller via the first asynchronous latch chain interface 120 significantly by introducing the possibility of “pre-processing” data stored in the memory device connected to the second data interface 130. Hence, by introducing a flexible, programmable and changeable data processing functionality to an embodiment of memory buffer 100, which is closely located to a memory device being connectable to a second data interface, at least a part of the necessary data processing can be carried out in the framework of the memory buffer, which leads to a relief of the bus system and other components, such as a processor of a computer system, being connectable to the first asynchronous latch chain interface 120.

Before describing the second embodiment of the present invention in more detail, it should be noted that objects, structures and components with the same or similar functional properties are denoted with the same reference signs. Unless explicitly noted otherwise, the description with respect to objects, structures and components with similar or equal functional properties and features can be exchanged with respect to each other. Furthermore, in the following, summarizing reference signs for objects, structures or components, which are identical or similar in one embodiment, or in a structure shown in one of the figures, will be used, unless properties or features of a specific object, structure or component is discussed. Using summarizing reference signs thereby enable, apart from the interchangeability of parts of the description as indicated before, a more compact and clearer description of embodiments of the present invention.

As outlined in the introductory part of the present application, especially for server applications a so-called fully buffered DIMM structure, which is also referred to as FBDIMM (DIMM=Dual Inline Memory Module), a special type of memory module has been introduced recently that allows accessing more memory modules from a single memory controller. Furthermore, this type of memory module along with an appropriate memory controller guarantees a far better signal integrity. FIG. 2 shows such an arrangement of a possible solution of fully buffered DIMMs or FBDIMM 200-1, 200-2, 200-n. Each of the FBDIMMs 200 comprises at least one memory device 210, typically a plurality or set of DRAM memory devices 210 arranged on a module board 220 of the FBDIMM 200. Typically, each FBDIMM 200 comprises 2, 4, 8, 16 or 32 individual DRAM memory devices 210, which are also denoted in FIG. 2 as DRAM components. The module board 220 of the FBDIMM 200 is often a printed circuitry board or another mechanical fixture to which electrical or optical guidelines (e.g., wires, circuits, and optical waveguides) are attached to or integrated into.

Furthermore, each FBDIMM comprises a memory buffer 100, which is also called “Advanced Memory Buffer” 100 or AMB 100. As each of the FBDIMM 200 comprises one memory buffer 100, the memory buffer 100 of the first FBDIMM 200-1 is denoted with reference sign 100-1. Accordingly, the AMB 100-2 of the FBDIMM 200-2 and the AMB 100-n of the FBDIMM 200-n are denoted accordingly. On each DIMM or FBDIMM 200, a chip, which is also called “Advanced Memory Buffer” or AMB, is arranged between a memory controller 230 or another FBDIMM 200 and the DRAM memory devices 210 of each of the FBDIMM 200.

As indicated earlier, the memory controller 230 and the FBDIMMs are arranged in the so-called daisy chain configuration. To be more precise, the memory controller 230 is connected via a unidirectional bus structure with a first embodiment of a memory buffer 100-1 of the first FBDIMM 200-1 such that the memory controller 230 can send data, commands, status requests and other signals to the AMB 100-1. This direction from the memory controller away is usually referred to as “southbound.” To be more precise, the memory controller 230 is connected to a bus structure, which in turn is connected to the first asynchronous latch chain interface 120 of the AMB 100-1. For instance, via a further asynchronous latch chain interface, the memory buffer 100-1 of the FBDIMM 200-1 is coupled to the first asynchronous latch chain interface of the AMB 100-2 of the FBDIMM 200-2. Accordingly, the further FBDIMM 200 or rather the AMBs 100 are connected in such a daisy chain configuration, until the last FBDIMM 200-n of the FBDIMMs is connected in the so-called southbound direction.

A similar bus structure connecting each AMB 100 with its neighboring component in the daisy chain is integrated in a further bus structure in the opposite direction, which is usually referred to as the “northbound” bus structure. Each AMB 100 is connected via the first asynchronous latch chain interface 120 and optionally via the further asynchronous latch chain interface to its neighboring components, which are either another FBDIMM 200 or the memory controller 230 in the case of the FBDIMM 200-1.

As indicated before, the communication along the daisy chain configuration of the memory system shown in FIG. 2 works in such a way that the memory controller 230, for instance, sends data, commands or other signals along the southbound bus structure to the first AMB 100-1 which checks if the data, the commands or the signals are intended for the AMB 100-1. If not, the data are forwarded via the southbound bus structure to the next AMB 100-2 of the FBDIMM 200-2. Accordingly, the data, instructions or other signals are provided from AMB 100 to its neighboring AMB 100 along the southbound bus structure until the data, instructions or signals are received at the AMB 100, for which they are intended. The intended AMB 100, for instance, the AMB 100-n, buffers the data and provides them via the second data interface to one of the memory modules 210 of the FBDIMM 200-n.

Accordingly, data stored in one of the memory devices 210 of, for instance, FBDIMM 200-2 are first buffered by the AMB 100-2 after they are received via the second data interface 130 of AMB 100-2, sent to AMB 100-1 via the northbound structure before AMB 100-1 provides the data received from AMB 100-2 to the memory controller 230.

To summarize, each of the AMBs 100 controls the interfaces and performs the buffering, in which embodiments of the memory buffer 100 can be implemented.

However, a possible solution of a memory buffer on the DIMM level in the current AMB/FBDIMM architecture only allows routing, while an implementation of an embodiment of a memory buffer 100 offers the new possibility of a real, programmable data processing. An advantage of implementing an embodiment of a memory buffer 100 into a FBDIMM 200, thereby enables a significant reduction of traffic on the bus structures in both southbound and northbound directions, as by utilizing the data processing capabilities of the processor 150 comprised in the embodiments of the memory buffers 100, the data from the memory devices coupled to the embodiments of the memory buffer 100 offer a data processing capability prior to the transfer to the memory controller 230.

In other words, this implies that the heavy traffic on the structures can be significantly reduced as, compared to a possible solution of an AMB without the data processing capabilities, all data stored in the memory devices 210 are not required to be sent to a microprocessor or host system via the memory controller 230 and then back again to the memory devices 210. In other words, employing an embodiment of a memory buffer 100 on a FBDIMM 200, as shown in FIG. 2, reduces the traffic on the bus structure between the memory controller 230 and the FBDIMMs 200, as only a fraction of the data has to be provided to the microprocessor of the host system via the memory controller 230 and the bus structure in many situations. In other words, an embodiment of a memory buffer 100 and an embodiment of a memory system offer a reduction of data traffic between the microprocessor of the host system and the DRAM memory modules of the FBDIMMs 200.

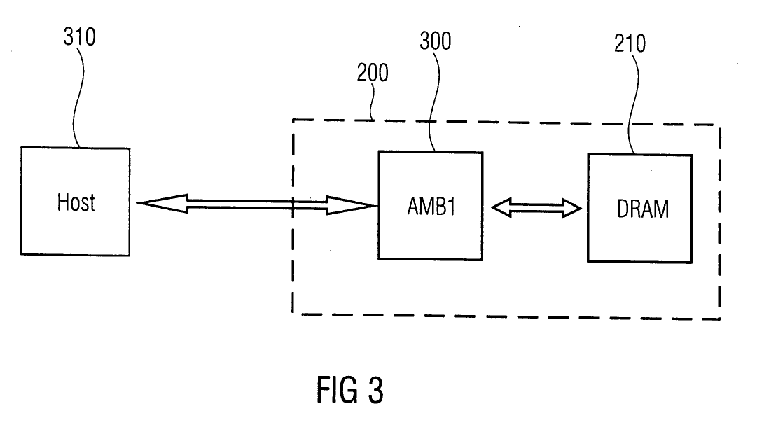

To illustrate the advantages of the embodiments of a memory buffer 100, as explained in the context of FIGS. 1 and 2, FIG. 3 shows a current arrangement of a FBDIMM 200 comprising a DRAM memory device 210 and a possible solution for a memory buffer 300, which is in FIG. 3, also labeled as “AMB1.” FIG. 3 furthermore shows a host system 310, which is connected by a bidirectional bus to the FBDIMM, wherein the bidirectional bus, to which the FBDIMM 200 is coupled, comprises a unidirectional bus structure for communicating with the FBDIMM 200 (southbound) and a bus structure for communicating in the opposite direction (northbound). FIG. 3 however, shows a simplified picture of a current arrangement of the host 310, the AMB 300 and the DRAM component 210.

As indicated earlier, in the current AMB/FBDIMM architecture on the DIMM level, there is only a routing implemented. As the possible solution of the memory buffer 300 allows no real data processing, all data from the DRAM memory device 210 or from the DRAM components, of which the memory device 210 is one memory device, has to be sent to the microprocessor of the host 310 and then back again into the appropriate memory unit of the memory device 210.

This possible solution of a memory buffer without data processing capabilities leads to heavy traffic on the bus connecting the host 310 and the FBDIMM 200, which will result in a potential bottleneck reducing the overall system speed. To be more precise, due to the reduced functionality of the possible solution of the memory buffer 300, compared to an embodiment of a memory buffer 100 comprising the changeable data processing functionality of the processor 150 with ever increasing memory density, the bandwidth of the bus system will represent the limiting factor (bottle neck) as all data stored in the memory devices 210 will result in a heavy data traffic at the AMB/host interface. In other words, as a possible solution, if an AMB 300 only comprises router functionality, all data to be processed has to be sent to the host system 310 or an appropriate memory controller comprised in the host system, thereby increasing the load of the respective bus heavily.

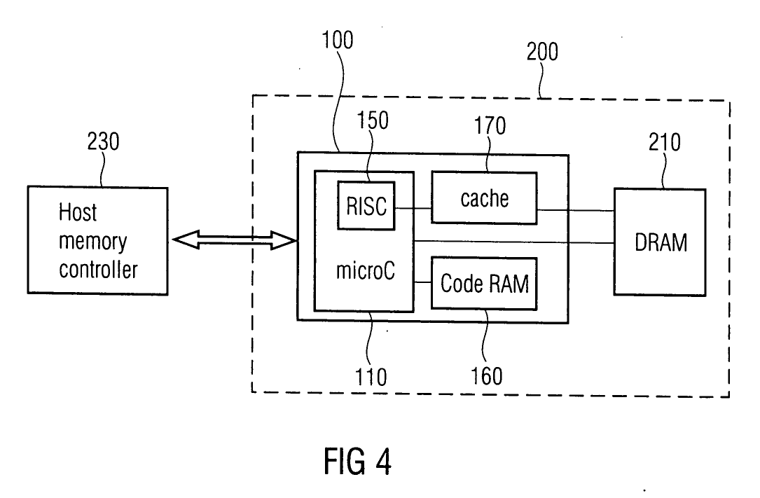

FIG. 4 shows a second embodiment of a memory buffer 100 in more detail, wherein in FIG. 4 not only the embodiment of the memory buffer 100 itself is shown but also a schematic implementation of a FBDIMM 200 along with a DRAM memory device 210. As already laid out in the context of FIG. 1, the embodiment of the memory buffer 100 comprises, apart from the interfaces not shown in FIG. 4, a processor 150, which is in the embodiment shown in FIG. 4, an RSIC processor. To be more precise, the processor 150 is comprised in a microcontroller 110 (“micro C”), which is comprised in the embodiment of the memory buffer 100. Apart from the processor 150, the microcontroller 110 further comprises the buffer 140, which is not shown in FIG. 4 so that the microcontroller 110 provides the buffering capabilities of the memory buffer 100, which is also referred to in FIG. 4 as “AMBnew.” As a consequence, the DRAM memory device 210 is coupled to the microcontroller 110 and to the processor 150 via a cache memory 170, to which the microcontroller 110 is also coupled. Furthermore, the embodiment of a memory buffer 100 comprises a memory 160 (“Code RAM”). The memory 160 is also coupled to the microcontroller 110 and allows a configuration of the embodiment of the memory buffer 100 via a programming signal received via the bus from a host memory controller 230.

The microcontroller 110 or rather the processor 150 (RISC processor) provides an instruction set so that microcontroller 110 or the processor 150 can be programmed to provide the data processing functionality, which is applied to data received from the DRAM memory device 210 or received via a asynchronous latch chain interface of the embodiment of the memory buffer 100. The program to be executed by the processor 150 can, for instance, be received from the host memory controller 230 and stored in the memory 160. In other words, the embodiment of the memory buffer 100 offers both a configurable memory 160 along with a microcontroller 110 comprising a processor 150 with an instruction set, which together allow a programming and a configuration of the data processing of the embodiment of the memory buffer 100.

The embodiment of the memory buffer 100 offers insertion of enhanced data processing capabilities, such as encryption, compression, error correction, error detection, data recognition and intermediate storage capabilities on the DIMMs or FBDIMMs 200 by incorporating an embodiment of an inventive memory buffer 100 as a novel AMB system. This offers an enhanced overall system performance as, for instance, the traffic on the bus connecting the memory controller 230 and the embodiment of the memory buffer 100 can be significantly reduced.

In this context it is to be noted that the arrangement of the host memory controller 230, the embodiment of the memory buffer 100, the DRAM memory module 210 and other DRAM components do not alter the general layout of the FBDIMM 200 significantly, and yet allow a complete new functionality to be introduced to the memory buffer in order to allow an on-DIMM processing of data. Hence, introducing programmability and the new data processing capabilities into a memory buffer 100 leads to a reduction of the data traffic at the host/AMB interface by allowing an on-DIMM data processing.

However, the possibilities of implementing a processor 150 into the microcontroller 110, or generally speaking, into the embodiments of the memory buffer 100 is not limited to a RISC processor or another specialized processor. To be more precise, the possibilities of such an enhanced AMB 100, as described above and with respect to an example of prefetching/strided access by a programmable cache partitioning below, can be extended and generalized by introducing more complex processes 150 with a more complex instruction set. Basically, the processor 150 itself, can also comprise a programmable instruction set, for instance, in the form of definable subroutines or other more complex command and control structures. The processor 150 can even be extended to comprise VLIW instructions (VLIW=Very Long Instruction Word) and further processor related architectures, for instance, allowing a further parallelization of the data processing. For example, complex VLIW instructions can be built by combining elementary commands in subroutines stored in the local memory 160 that can be both volatile and non-volatile. Hence, by implementing the memory 160 in such a way that it comprises, for instance, both a volatile submemory (e.g., DRAM, SRAM) and a non-volatile memory (e.g., flash memory), the embodiment of a memory buffer 100 can be programmed with subroutines, which can be stored in the non-volatile submemory of the memory 160, so that basic subroutines and functions to be performed regularly can be stored in a non-volatile way to prevent erasing when the memory system is turned off. Hence, it is possible to reduce the programming of the data processing functionality of the processor 150 to only having to program the memory 160 (at least with respect to the non-volatile submemory) once, which further reduces the traffic on the bus between the host memory controller and the embodiment of the memory buffer 100. As a consequence, the “Code RAM” shown in FIG. 4 can also comprise a non-volatile memory or even a read-only submemory (ROM).

The concept of introducing a programmable, changeable data processing functionality to an embodiment of a memory buffer 100 in the form of a processor 150 and an optional memory 160, comprising a volatile, a non-volatile and/or a read-only submemory offers the performance of even complex operations, such as matrix multiplication and matrix summation, which are the basis of even more complex data processing algorithms, like FFT (Fast Fourier Transform) or DCT (Direct Cosine Transform), etc. The data processing functionality can of course, also comprise the ability of a complex number processing.

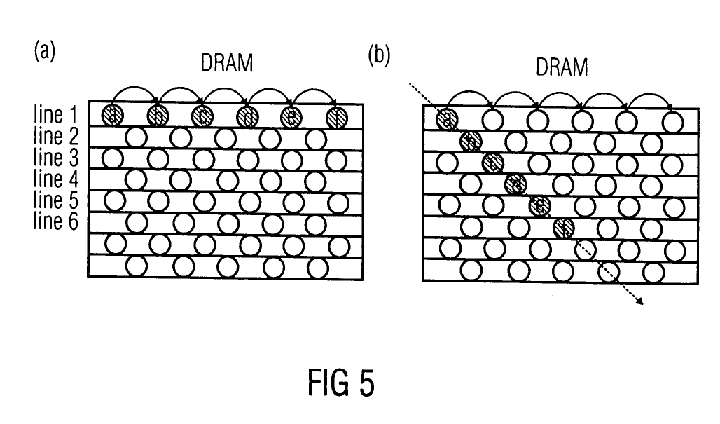

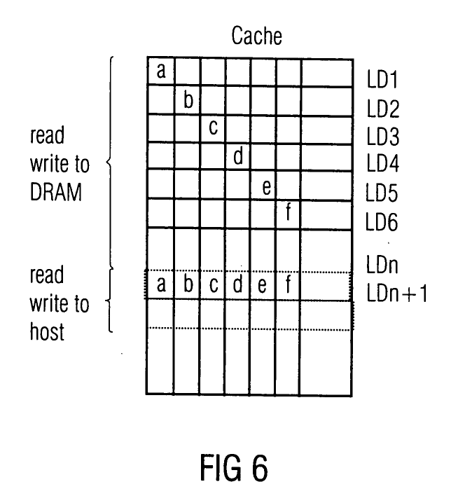

As indicated earlier, a first example for a data processing functionality will be described in the context of FIGS. 5 and 6, coming from the field of prefetchings/strided access being provided by programmable cache partitioning, which offers a significant reduction of traffic on the bus.

In many possible implementations of memory devices, data is read in terms of “lines” and optionally stored within a cache memory of the host memory controller. Such a reading of a line is illustrated in FIG. 5a. Depending on the memory technology used for a memory device 210, the lines can be associated with a geometrical pattern of the memory cell field of the memory device itself. However, depending on the technology involved, a line, as shown in FIGS. 5a and 5b, is not necessarily associated with a geometrical pattern of the memory cell field. For instance, a line can be associated with a (physical) column address so that, for instance, different lines correspond to different row addresses. However, if, for instance, a transformation between logical addresses and physical addresses is involved, a line can also be associated with a data pattern associated with a logical address so that a line is not related to a fixed pattern concerning the memory self field or the physical address space at all. In such a case, a line can in principle change over time with respect to the memory cells physically involved. In other words, a line may in principle be only a momentarily associated number of memory cells.

FIG. 5a shows a situation in which data denoted by the circles a to f, are arranged in the memory along a single line (line 1) so that the data can be accessed directly. This implies that in principle, all data should be arranged along the lines that can be accessed directly to offer an effective reading process.

However, in current setups the reading processes are very often highly inefficient, as the requested data are very often not stored along a single “reading line,” but, for example, along a diagonal, as illustrated in FIG. 5b. In the example shown in FIG. 5b, each desired piece of data, denoted by the circles a to f, is located in a different line of the lines 1 to 6. As a consequence, all the lines have to be read, and the corresponding data have to be transmitted to the memory controller in the case of a possible solution without employing an embodiment of a memory buffer with a changeable data processing functionality. In other words, to read the data sequence a to f, as shown in FIG. 5b, it is necessary to read and to transmit all the data from line 1 to line 6 to the memory controller of the host system in the case of using a memory buffer without data processing capabilities.

In other words, as the data readout in the case of a DRAM memory device is done along lines, the readout of the required sequence a to f is efficient only with a system having a possible solution of a memory buffer 300 without the changeable data processing functionality of an embodiment of a memory buffer 100 if the data are arranged along a single line. If, however, the required sequence a to f is arranged along a diagonal, the complete set of data from line 1 to line 6 have to be transmitted in this case to the host memory controller, which causes heavy traffic on the bus.

However, using an embodiment of the memory buffer 100, comprised in the setup of a new AMB 100 with caching and processing capabilities, the data requested from the host memory controller 230 is prefetched in the cache memory 170, and thus only the necessary data is sent via the bus being connected to the first asynchronous latch chain interface 120 to the host memory controller 230.

To be more precise, the data from each of lines 1 to 6, as shown in FIG. 5b, that contain the required information will be read from one of the memory devices 210 and stored into a part of the cache memory 170 corresponding to the lines LD1 to LDn as shown in FIG. 6. Each line in the cache memory 160 is mathematically represented by a vector, so that basic vector and matrix operations allow writing the required data into another line LDn+1 of the cache memory 160. The instructions and the code required to perform the basic vector and matrix operations can easily be stored in the memory 160 (cf. Code “RAM” in FIG. 4) and performed or executed by the processor 150 in the microcontroller 110. The contents of the line LDn+1 of the cache memory 170 is then transmitted to the host memory controller 230 via the first asynchronous latch chain interface and the northbound bus structure of the bus connecting the memory controller 230 and the respective FBDIMM 200.

In other words, FIG. 6 shows an example of partitioning of the cache memory 170 in the framework of an embodiment of a memory buffer 100 and the associated new AMB setup. The upper part of the cache memory (lines LD1 to LD6) is used to read data from the DRAM memory device 210, whereas the lower parts (lines LDn and LDn+1) contain the processed data, which is sent to the memory host controller 230.

Whenever the data of the information is not stored in addresses, memory cells, columns or rows, such that the data are not stored in neighboring memory cells in the sense of belonging to one line, complying a possible solution of a memory buffer without a data processing functionality results in a less favorable performance. Furthermore, in some memory technologies, the column addresses are automatically transferred into lines due to the symmetry of the memory self field.

In other words, an embodiment of a memory buffer 100, an embodiment of a memory system and an embodiment of a memory module, as well as embodiments of the method for buffering data and the method for programming a memory buffer can be implemented in the framework of a system to offer buffering and complex processing routines on a memory DIMM 20 or FBDIMM 200, by a specialized instruction set and programmable microcontroller 110 on the DIMM or FBDIMM 200 or an embodiment of a memory buffer 100.

Although the embodiments of a memory buffer, a memory system and a memory module have been mainly been described and discussed in the framework of an advanced memory buffer in the context of a fully buffered DIMM, embodiments of the present invention can also be employed in the field of buffered DIMMs and other memory systems. An important application comes from the field of graphic applications, in which a graphical processing unit (GPU) can be relieved in terms of computational complexity by transferring simple and repeatedly occurring data processing steps to an embodiment of the memory buffer. Hence, the embodiments of the present invention may also be utilized in the field of graphic systems comprising an embodiment of a memory buffer with an option of a cache memory, a set of instructions of the processor comprised in the embodiment of the memory buffer, wherein the processor is programmable by a programming signal to change the data processing functionality depending on the requirements of the system.

Furthermore, it should be noted that in principle the data signal can of course comprise program code, which is intended for the processor of an embodiment of a memory processor, but stored temporarily in the memory device being connected to the second data interface of an embodiment of the memory buffer. Furthermore, it should be noted, that depending on the technology used for the memory device, the second data interface can, for instance, be a parallel data interface or a serial data interface. Furthermore, the second data interface can, in principle, be a synchronous or an asynchronous interface. Moreover, depending on the concrete implementation of the embodiment of the present invention, an interface can be both an optical or an electrical interface. Furthermore, an interface can comprise a terminal, a connector, a bus, an input, an output, a jumper to switch or another form of connector for providing a signal. Furthermore, all interfaces can be conveying signals in a parallel or serial manner. Furthermore, single ended signals as well as differential signals can be used. Moreover, multilevel signals, which are also referred to as discreet signals, binary or digital signals, can be used.

Furthermore, in all embodiments of an inventive memory buffer, the programming signal can be received via the first asynchronous latch chain interface or the second data interface. However, as a further alternative, the programming signal may also be received via a further interface, which can, for instance, be the so-called SM-bus of the FBDIMM architecture, which connects the memory controller 230 and all memory buffers on all FBDIMMs with a comparably low transmission frequency.

Depending on certain implementation requirements of embodiments of the inventive methods, embodiments of the inventive methods can be implemented in hardware or in software. The implementation can be performed using a digital storage medium, in particular, a disc, a CD or a DVD having the electronically readable control signal thereon, which cooperates with a programmable computer or a processor, such that an embodiment of the inventive methods is performed. Generally, an embodiment of the present invention is, therefore, a computer program product with a program code stored on a machine-readable carrier, the program code being operative for performing an embodiment of the inventive methods when the computer program product runs on the computer or processor. In other words, embodiments of the inventive methods are therefore, a computer program having a program code for performing at least one of the embodiments of the inventive methods, when the computer program runs on the computer.

While the foregoing has a particularly shown and described with reference to particular embodiments thereof, it will be understood by those skilled in the art that various other changes in the form and details may be made without departing from the spirit and scope thereof. It is to be understood that various changes may be made in adapting to different embodiments without departing from the broader concept disclosed herein and comprehended by the claims that follows.

What is claimed is:

1. A memory buffer, comprising:
a first interface comprising an asynchronous latch chain interface connectable to at least one of a memory controller and a memory buffer;
a second interface comprising a data interface connectable to a memory device; and
a circuit comprising a buffer and a processor, the circuit being coupled to the first and second interfaces so that data can be passed between the first interface and the buffer and between the second interface and the buffer, and so that the processor is able to process at least one of the data from the first interface to the second interface and/or the data from the second interface according to a data processing functionality,
wherein the data processing functionality of the processor is changeable by a programming signal received via an interface of the memory buffer.

2. The memory buffer according to claim 1, wherein the processor is a RISC processor providing the data processing functionality based on a specific set of instructions.

3. The memory buffer according to claim 1, wherein the data processing functionality comprises at least one of encrypting data, decrypting data, error correcting data, error detecting data, fast Fourier transforming data, and direct cosine transforming data.

4. The memory buffer according to claim 1, wherein the circuit further comprises a memory coupled to the processor such that a code comprised in the programming signal indicative of the data processing functionality of the processor can be stored to the memory or provided from the memory to the processor.

5. The memory buffer according to claim 1, wherein the circuit further comprises a cache memory accessible by the processor in processing the data.

6. The memory buffer according to claim 1, wherein the second data interface is a DDRx interface.

7. The memory buffer according to claim 1, further comprising a further asynchronous latch chain interface connectable to a further memory buffer, wherein the further interface is coupled to the circuit so that data can be passed between the buffer and the further interface.

8. The memory buffer according to claim 7, wherein the further interface is coupled to the circuit such that the processor is further capable of processing data between the first interface and the further interface according to the data processing functionality.

9. The memory buffer according to claim 1, wherein the processor is coupled to the first interface so that the programming signal can be received via the first interface of the memory buffer or a further communication interface.

10. The memory buffer according to claim 1, wherein the memory buffer is mounted on a module board, wherein the module board comprises a module board interface coupled to the first interface of the memory buffer and wherein the module board further comprises at least one memory device arranged on the module board such that the at least one memory device is coupled to the second interface of the memory buffer.

11. The memory buffer according to claim 1, wherein the memory device comprises a DRAM memory device.

12. A memory buffer, comprising:
a first interface comprising an asynchronous latch chain interface connectable to at least one of a memory controller and a memory buffer;
a second interface connectable to a memory device; and
a circuit comprising a buffer and a processor, the circuit being coupled to the first interface and the second interface for buffering data between the first interface and the buffer and for buffering data between the second interface and the buffer, and so that the processor is capable of processing data between the first interface and the second interface according to a changeable data processing functionality based on a programming signal received via the first interface of the memory buffer or a further communication interface.

13. The memory buffer according to claim 12, wherein the processor is a RISC processor providing the changeable data processing functionality based on a specific set of instructions.

14. The memory buffer according to claim 12, further comprising a memory for storing a code comprised in the programming signal and coupled to the circuit such that the processor is able to carry out the changeable data processing functionality based on the code stored in the memory.

15. The memory buffer according to claim 12, wherein the circuit further comprises a cache memory accessible by the processor in processing the data.

16. The memory buffer according to claim 12, further comprising a further asynchronous latch chain interface connectable to a further memory buffer, wherein the circuit is coupled to the further interface so that the buffer is able to buffer data passed between the circuit and the further interface.

17. The memory buffer according to claim 12, wherein the memory buffer is mounted on a module board further comprising a module interface connected to the first interface of the memory module and at least one memory device arranged on the module board and connected to the second interface of the memory buffer, wherein the at least one memory device is a DRAM memory device.

18. An apparatus for buffering data, the apparatus comprising:
a first means for exchanging data via an asynchronous latch chain interface;
a second means for exchanging data via a second data interface;
means for buffering the data received from the first means for exchanging and the second means for exchanging; and
means for processing at least one of the data received from the first means for exchanging data and provided to the second means for exchanging data or the data received from the second means for exchanging data based on a changeable data processing functionality based on a programming signal received from at least one of the first means for exchanging data and the second means for exchanging data.

19. The apparatus according to claim 18, further comprising means for storing and for providing a code comprised in the programming signal indicative of the changeable data processing functionality to the means for processing the data.

20. The apparatus according to claim 18, wherein the means for buffering further comprises a further means for exchanging data via a further asynchronous latch chain interface, wherein the means for buffering is for buffering data passed between the further means for exchanging data and the means for buffering.

21. A method for buffering data, the method comprising:
receiving a code indicative of data processing functionality;
receiving data from a first asynchronous latch chain interface or a second data interface;
buffering the received data;
processing the received data or the buffered data based on the code and according to the data processing functionality; and
providing the data processed to the first asynchronous latch chain interface or the second data interface.

22. The method according to claim 21, wherein the processing of the data comprises at least one of encrypting the data, decrypting the data, error correcting the data, error detecting the data, fast Fourier transforming the data, and direct cosine transforming the data.

23. The method according to claim 21, further comprising:
storing the code indicative of the data processing functionality; and
providing the code for processing the data.

24. A method for programming a memory buffer comprising a first asynchronous latch chain interface connectable to at least one of a memory controller and a memory buffer;
a second data interface connectable to a memory device; and
a circuit comprising a buffer and a processor, the circuit being coupled to the first and second interfaces so that data can be passed between the first interface and the buffer and between the second interface and the buffer, and so that the processor is capable of processing at least one of the data from the first interface to the second interface and the data from the second interface according to data processing functionality,
wherein the data processing functionality of the processor is changeable by a programming signal received via an interface of the memory buffer; and
the method further comprising providing the programming signal comprising a code indicative of the data processing functionality to an interface of the memory buffer.

25. The method according to claim 24, wherein the code comprises at least one instruction from a special set of instructions of the processor.

26. The method according to claim 24, wherein the code is indicative of a data processing functionality comprising at least one of encrypting data, decrypting data, error correcting data, error detecting data, fast Fourier transforming data and direct cosine transforming data.

27. A computer program for performing, when running on a computer, a method for buffering data, the method comprising:
receiving a programming signal comprising a code indicative of a data processing functionality;
receiving data from a first asynchronous latch chain interface or a second data interface;
buffering the received data;
processing the received data or the buffered data based on the code according to the data processing functionality; and
providing the data processed to the first asynchronous latch chain interface or the second data interface.

28. A computer program for performing, when running on a computer, a method for programming a memory buffer comprising a first asynchronous latch chain interface connectable to at least one of a memory controller and a memory buffer;
a second data interface connectable to a memory device;
a circuit comprising a buffer and a processor, the circuit being coupled to the first and second interfaces so that data can be passed between the first interface and the buffer and between the second interface and the buffer, and so that the processor is capable of processing at least one of data from the first interface and to the second interface and data from the second interfaces according to data processing functionality,
wherein the data processing functionality of the processor is changeable by a programming signal received via an interface of the memory buffer; and
the method comprising providing the programming signal comprising the code indicative of the data processing functionality to an interface of the memory buffer.

29. A memory system comprising:
a memory controller;
at least one memory device; and
a memory buffer comprising:
a first interface comprising an asynchronous latch chain interface coupled to the memory controller;
a second interface comprising a data interface coupled to the at least one memory device; and
a circuit comprising a buffer and a processor, the circuit being coupled to the first and second interfaces so that data can be passed between the first interface and the buffer and between the second interface and the buffer, and so that the processor is capable of processing at least one of the data from the first interface to the second interface and the data from the second interface according to a data processing functionality,
wherein the data processing functionality of the processor is changeable by a programming signal received via an interface of the memory buffer.

30. A memory module, comprising:
a module board with a module interface;
at least one memory device arranged on the module board; and
a memory buffer comprising:
a first interface comprising an asynchronous latch chain interface coupled to the module interface;
a second interface comprising a data interface coupled to the at least one memory device; and
a circuit comprising a buffer and a processor coupled to the first and second interfaces so that data can be passed between the first interface and the buffer and between the second interface and the buffer, and so that the processor is capable of processing at least one of the data from the first interface to the second interface and data from the second interface according to a data processing functionality,
wherein the data processing functionality of the processor is changeable by a programming signal received via an interface of the memory buffer.
